(19) United States
(12) Patent Application Publication
(10) Pub. No.: US 2012/0071297 A1
(43) Pub. Date: Mar. 22, 2012

(54) CONTROL DEVICE OF VEHICLE POWER TRANSMISSION MECHANISM

(75) Inventors: Kazuya Enomoto, Shizuoka (JP); Kazuhiko Suzuki, Shizuoka (JP)

(73) Assignee: SUZUKI MOTOR CORPORATION, Shizuoka (JP)

(21) Appl. No.: 13/230,232

(22) Filed: Sep. 12, 2011

(30) Foreign Application Priority Data
Sep. 16, 2010 (JP) 2010-207824

(51) Int. Cl. B60W 10/02; B60W 30/18

(52) U.S. Cl. 477/86

(57) ABSTRACT

A control device provided with a first map capable of performing coast down control of altering a transmission ratio of a continuously variable transmission at a time of deceleration of a vehicle has a second map which is set by making a lock-up release vehicle speed for releasing a lock-up clutch and an engine rotation frequency correspond to each other, wherein, when cost down control is performed, the second map is used to set a lock-up release vehicle speed for releasing the lock-up clutch.

### CROSS-REFERENCE TO RELATED APPLICATIONS

This application is based upon and claims the benefit of priority of the prior Japanese Patent Application No, 2010-207824, filed on Sep. 16, 2010, the entire contents of which are incorporated herein by reference.

### BACKGROUND OF THE INVENTION

1. Field of the Invention

The present invention relates to a control device of a vehicle power transmission mechanism, in particular to a control device of a vehicle power transmission mechanism which includes a continuously variable transmission and a hydraulic power transmission unit with lock-up clutch and which performs fuel cut recovery and lock-up release of an internal combustion engine.

2. Description of the Related Art

In fuel injection control of an internal combustion engine (engine) mounted on a vehicle, deceleration-time fuel cut control is done in some cases as one of fuel cut control.

For example, a control device of a vehicle power transmission mechanism performs deceleration-time fuel cut at a time of satisfaction of respective conditions that an accelerator opening degree (or a throttle opening degree) is equal to or less than a specified value, that a vehicle speed is equal to or more than a specified value, and that an engine rotation frequency is equal to or more than a specified value. Thereby, it is set so that a time of fuel cut is taken as long as possible, thereby to realize HC suppression and fuel efficiency improvement.

A target idle rotation frequency is set as a minimum rotation frequency at which the internal combustion engine can stably drive. Further, it is controlled so that the rotation frequency of the internal combustion engine becomes equal to or more than the target idle rotation frequency also in a case that the accelerator opening degree (or the throttle opening degree) at which an idle switch turns on is equal to or less than the specific value. The target idle rotation frequency is altered to increase/decrease in correspondence with a state (for example, a cooling water temperature or the like) of the internal combustion engine or a mechanical load or an electric load (for example, a compressor for A/C, a power generator or the like) applied to the internal combustion engine. Thereby, a fuel cut recovery rotation frequency (it is an engine rotation frequency at which recovery is done from a fuel cut state to a state in which fuel is supplied. The same applies hereinafter) which is set to be somewhat higher than the target idle rotation frequency is also altered on demand.

In lock-up control of a lock-up clutch in a control device of a vehicle power transmission mechanism which includes a continuously variable transmission (CVT) and a hydraulic power transmission unit (torque converter) with lock-up clutch, a transmission control module (CVT control module: TCM) outputs a signal to a lock-up solenoid thereby to make the lock-up clutch in the hydraulic power transmission unit with lock-up clutch be engaged, when lock-up control execution conditions are satisfied (for example, by satisfaction of a drive range and satisfaction of a transmission oil temperature and an engine water temperature being equal to or more than specific values), based on information of a vehicle speed, a transmission (CVT) oil temperature, a primary pulley rotation speed or the like.

The control device of the vehicle power transmission mechanism enlarges a lock-up control operation region so that a lock-up operation is done until reaching a low speed region, thereby to improve a transmission efficiency also at a time of deceleration of the vehicle and to enlarge a fuel cut operation region, consequently improving the fuel efficiency. It should be noted that when an input shaft rotation speed and a vehicle speed becomes less than specific values, a lock-up control release condition is satisfied.

A transmission (including a continuously variable transmission and a stepped automatic transmission) of a vehicle power transmission mechanism sometimes performs a downshift, that is, a coast downshift in accordance with reduction of a vehicle speed, at a time of deceleration of a vehicle.

In particular, the continuously variable transmission can alter a transmission ratio continuously without a step between a transmission ratio (Lowest) where a speed reduction ratio becomes a maximum to a transmission ratio (Highest) where the speed reduction ratio becomes a minimum (a speed increasing ratio is a maximum). Thus, in the control device of the vehicle power transmission mechanism, a coast down line which is used at a time of deceleration is set in a shift map for setting the transmission ratio. It should be noted that in a shift map (see FIG. 8, FIG. 9), an equal transmission ratio has a linear line with different inclinations.

Further, it is possible for the control device of the vehicle power transmission mechanism not to control to follow the coast clown line at the time of deceleration of the vehicle. For example, it is possible for the control device of the vehicle power transmission mechanism to perform coast downshift smoothly and continuously, and during that time, to match an engine rotation frequency to a certain rotation frequency (for example, a target idle rotation frequency, a fuel cut recovery rotation frequency or the like), maintaining the engine rotation frequency constant (see turbine rotation frequency behavior in FIG. 8, FIG. 9).

In general, the control device of the vehicle power transmission mechanism controls lock-up release so that fuel cut recovery does not occur in a lock-up engagement state during deceleration of the vehicle, used on the fuel cut recovery rotation frequency of the internal, combustion engine (see FIG. 7).
[Patent Document 1] Japanese Laid-open Patent Publication No, 2010-174973

A control device of a vehicle power transmission mechanism according to Patent Document 1 described above is a control device of a vehicle power transmission mechanism which includes a continuously variable transmission and a hydraulic power transmission unit with lock-up clutch, and improves drivability by giving consideration to lock-up release and fuel cut recovery during deceleration of a vehicle.

However, an object of a constitution described in Patent Document 1 above is to eliminate uncomfortable feeling due to a pop-up feeling of the vehicle or the like. In Patent Document 1, consideration is not given to a technical problem to prevent generation of a shock by recovery from fuel cut due to overlapping of an alteration or a fluctuation of a target idle rotation frequency in relation to a change of an engine rotation frequency according to a shift property of the continuously variable transmission, and a concrete technique thereof is not disclosed either.

Further, in a stepped automatic transmission, since coast downshift brings about a large fluctuation of an engine rotation frequency by switching of a shift speed, a shock is generated at a shift timing. In contrast, in a continuously variable transmission, such a gap between shift speeds does not exist and a shock by continuous minute shifts is not generated.

In other words, conventionally, though a fuel cut recovery rotation frequency fluctuates in correspondence with operation states of an engine water temperature and an air conditioning system, lock-up control does not correspond to such a fluctuation. Therefore, when the fuel cut recovery rotation frequency largely fluctuates, sometimes timings of fuel cut recovery and lock-up release do not match. As a result, there is a possibility that a shock is generated or an engine stall occurs at a time of fuel cut recovery.

Explanation will be done by using FIG. 9 and FIG. 10 as examples. At a time of deceleration of a vehicle in a state in which a fuel cut recovery rotation frequency is high, when a transmission ratio of a continuously variable transmission reaches the Lowest, an engine rotation frequency is reduced. As a result, a state of control of an internal combustion engine recovers from that of fuel cut (indicated by a time t1 in FIG. 10) before lock-up release (indicated by a time t2 in FIG. 10). Accordingly, a shock is generated (indicated by S in FIG. 10). Further, there is a possibility that an engine stall occurs by the engine rotation frequency becoming lower than a target idle rotation frequency.

Therefore, in lock-up control, it is important, in view of fuel efficiency improvement and shock avoidance, no coordinate lockup release and recovery from fuel cut at a time of deceleration of a vehicle in fuel cut control, and improvement has been desired.

### SUMMARY OF THE INVENTION

Thus, an object of the present invention is to improve drivability by giving consideration to overlapping of a change of an engine rotation frequency and alteration/fluctuation of a target engine rotation frequency in accordance with a shift property of a continuously variable transmission, and to provide a control device of a vehicle power transmission mechanism capable of performing coordinated control without a shock and an engine stall by paying attention to timings of lock-up release and fuel cut recovery during deceleration of a vehicle.

The present invention is a control device of a vehicle power transmission mechanism connected to an internal combustion engine in which fuel cut and recovery is performed at a time of deceleration of a vehicle, the vehicle power transmission mechanism including a continuously variable transmission and a hydraulic power transmission unit with lock-up clutch, the control device of the vehicle power transmission mechanism being provided with a first map by which lock-up control of controlling engagement or release of the lock-up clutch is performed at a time of satisfaction of a predetermined condition and by which coast down control of altering a transmission ratio of the continuously variable transmission at a time of deceleration of the vehicle can be performed, the control device of the vehicle power transmission mechanism has: a second map which is set by making a lock-up release vehicle speed at which the lock-up clutch is released and an engine rotation frequency correspond to each other, wherein, when coast down control is performed, the second map is used to set a lock-up release vehicle speed at which the lock-up clutch is released.

### BRIEF DESCRIPTION OF THE DRAWINGS

FIG. 1 is a system configuration diagram of a control device of a vehicle power transmission mechanism (embodiment);

FIG. 2 is a map for calculating a lock-up release vehicle speed (embodiment);

FIG. 3 is a flowchart of control of a vehicle power transmission mechanism (embodiment);

FIG. 4 is a graph of a first map (embodiment);

FIG. 5 is a graph of a second map (embodiment);

FIG. 6 is a time chart of fuel cut recovery, a lock-up release vehicle speed, and a lock-up engagement oil pressure (embodiment);

FIG. 7 is a time chart for determining a lock-up release vehicle speed VSP₁ and a lock-up lower limit vehicle speed VSP₂ by a magnitude relation (Nemin1, Nemin2) of target minimum engine rotation frequencies (embodiment);

FIG. 8 is a graph of a conventional, first map (conventional example);

FIG. 9 is a graph of a conventional second map (conventional example); and

FIG. 10 is a conventional time chart of fuel cut recovery, a lock-up release vehicle speed, and a lock-up engagement oil pressure (conventional example).

### DETAILED DESCRIPTION OF THE PREFERRED EMBODIMENTS

The present invention realizes an object, that is, improving drivability by giving consideration to overlapping of a change of an engine rotation frequency and an alteration/fluctuation of a target engine frequency in accordance with a shift property of a continuously variable transmission and performing coordinated control without a shock or an engine stall by paying attention to timings of lock-up release and fuel cut recovery during deceleration of a vehicle, by having a second map set by making a lock-up release vehicle speed for releasing a lock-up clutch and an engine rotation frequency correspond to each other and, when coast down control is performed, by using the second map to set a lock-up release vehicle speed for releasing the lock-up clutch.

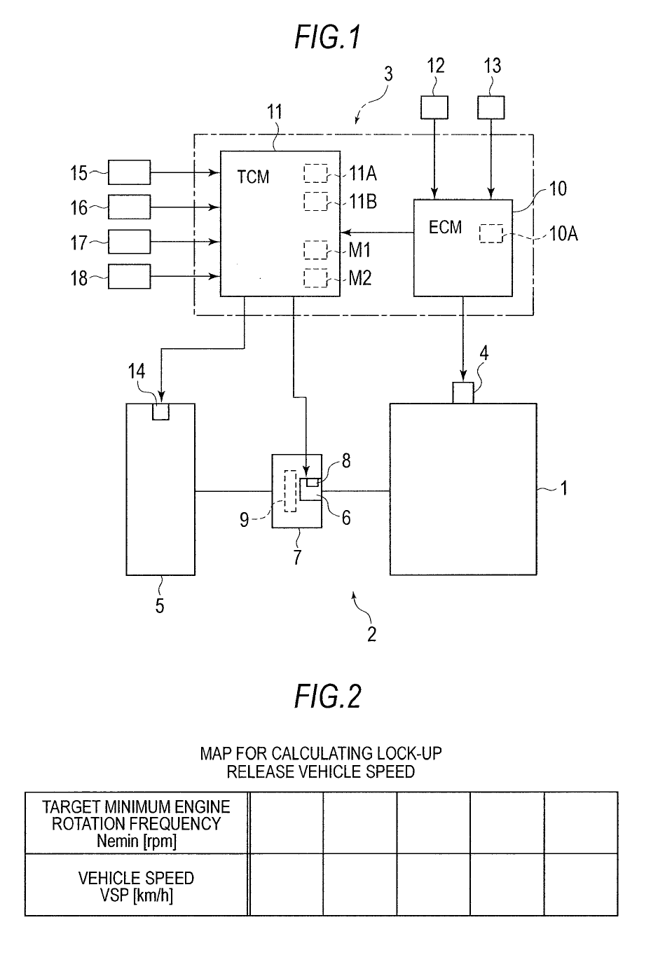

FIG. 1 to FIG. 7 illustrate an embodiment of the present invention.

In FIG. 1, a reference number 1 indicates an internal combustion engine mounted on a vehicle, a reference number 2 indicates a vehicle power transmission mechanism connected to the internal combustion engine 1, and a reference number 3 indicates a control device of the vehicle power transmission mechanism 2

The internal combustion engine 1 has a fuel injection valve 4 which constitutes a fuel control unit.

The vehicle power transmission mechanism 2 includes a continuously variable transmission (CVT) 5 and a hydraulic power transmission unit (torque converter) 7 with lock-up clutch, and is connected to the internal combustion engine 1. The hydraulic power transmission unit 7 with lock-up clutch has a lock-up clutch 6 and is constituted by components such as a turbine 9. The lock-up clutch 6 has a lock-up solenoid valve 8.

The control device 3 is constituted by an engine control module (ECM) 10 and a transmission control module (TCM) 11 communicating with the engine control module 10.

The engine control module 10 actuation-controls the fuel injection valve 4. A fuel control section 10A performs fuel cut and recovery of the internal combustion engine 1 at a time of deceleration of a vehicle. Further, with the engine control module 10 communicate a temperature sensor 12 which detects a cooling water temperature of the internal, combustion engine 1 and an engine rotation frequency sensor 13 which detects an engine rotation frequency.

The transmission control module 11 actuation controls each valve 14 of the continuously variable transmission 5 and the lockup clutch 6 of the hydraulic power transmission unit 7 with lock-up clutch, respectively.

With the transmission control module 11 communicate a primary rotation sensor 15 capable of detecting a turbine rotation frequency of the turbine 9 as an input rotation detecting means of the continuously variable transmission 5, an oil temperature sensor 16 as an oil temperature detecting means of the continuously variable transmission 5, a vehicle speed sensor 17 as a vehicle speed detecting means, and an idle switch 18 which detects an idle driving state of the internal combustion engine 1.

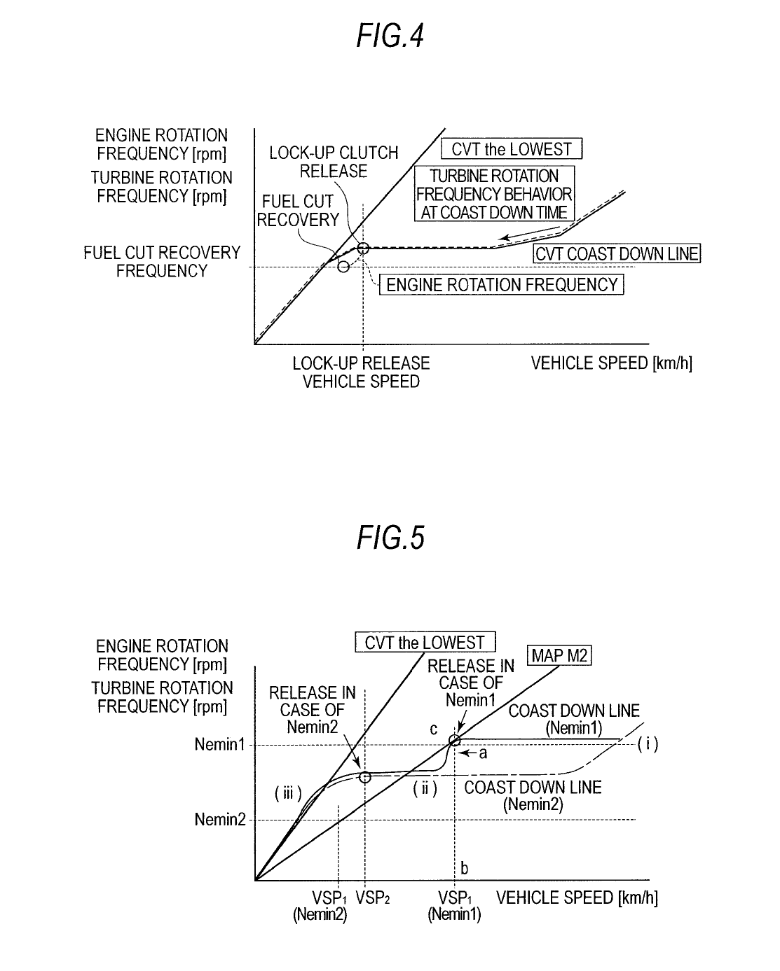

Besides, the transmission control module 11 includes a lock-up control section 11A and a setting section 11B, and has a first map M1 (see FIG. 4: shift map) and a second map M2 (see FIG. 5: shift map). The lock-up control section 11A performs lock-up control of controlling engagement or release of the lock-up clutch 6 at a time of satisfaction of a predetermined condition. The first map M1 is used for coast down control of altering a transmission ratio of the continuously variable transmission 5 at a time of deceleration of the vehicle. The second map M2 is a map used for setting of a lock-up release vehicle speed (sometimes also referred to as “lock-up prohibition vehicle speed”) at which the lock-up clutch 6 is released, and is a map set as a result that the lock-up release vehicle speed is made correspond to the engine rotation frequency. The setting section 11B sets the lock-up release vehicle speed at an execution time of coast down control by using the second map M2. The lock-up release vehicle speed means a vehicle speed at which the lock-up clutch 6 is released.

Thereby, the transmission control module 11 is able to make the lock-up release vehicle speed which determines a timing for releasing the lock-up clutch 6 correspond to a fluctuation of a target engine rotation frequency. Therefore, it is possible to achieve both improvement of a fuel efficiency and prevention of shock generation due to fuel cut recovery.

Further, the transmission control module 11 compares the lock-up release vehicle speed which is set by using the second map M2 and a lock-up release vehicle speed which is set by other than the second map M2, and sets the lock-up release vehicle speed having a higher value as the lock-up release vehicle speed.

Thereby, switching of the vehicle speed can be optimally performed. Therefore, in particular, it is possible to achieve both improvement of the fuel efficiency and prevention of the shock generation due to fuel cut recovery.

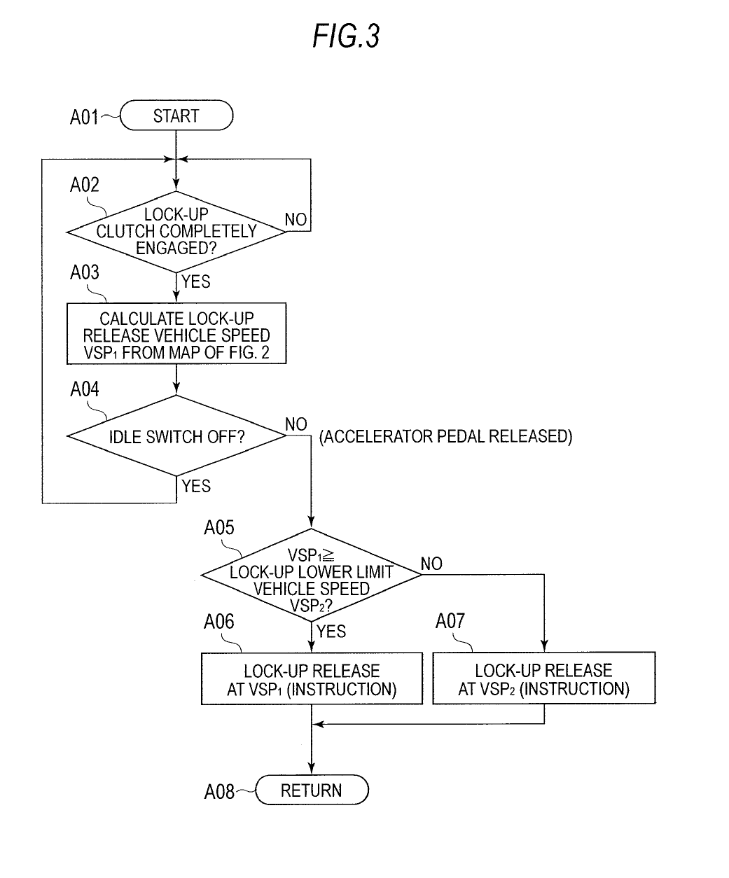

Further, the transmission control module 11 has a map for calculating a lock-up release vehicle speed VSP₁ as presented in FIG. 2. As presented in the map of FIG. 2, the lock-up release vehicle speed VSP₁ is set by a target minimum engine rotation frequency Nemin and a vehicle speed VSP.

It should be noted that the transmission control module 11 has, for example, a storage means (RAM, ROM or the like) capable of storing the above-described respective maps and a computer program (software), and a CPU which reads the program from the storage means and executes (illustration of both is omitted). Then, as a result that the CPU reads the computer program from the storage means and executes, the transmission control module 11 functions as the lock-up control section 11A, the setting section 11B and so on.

Next, control, according to this embodiment will be explained based on a flowchart of FIG. 3.

Control described below is stored in the storage means of the transmission control module 11 as a computer program (software). Then, the CPU of the transmission control module 11 reads this computer program from the storage means and executes. Thereby, the control according to this embodiment is executed.

As presented in FIG. 3, the transmission control module 11, when starting the program (step A01), first judges whether or not the lock-up clutch 6 is completely engaged (step A02), and if the step A02 is NO, the above judging is continued.

If the step A02 is YES, the transmission control module 11 calculates a lock-up release vehicle speed VSP₁ from the map of FIG. 2 (step A03).

Then, the transmission control module 11 judges whether or not the idle switch 16 is off (step A04).

If the step A04 is YES, the transmission control module 11 judges that it is a state in which an accelerator pedal is depressed, and return a procedure to the above step A02.

If the step A04 is NO, the transmission control module 11 judges that it is a state in which the accelerator pedal is released, and judges whether or not the lock-up release vehicle speed VSP₁≧lock-up lower limit vehicle speed VSP₂ (step A05).

If the step A05 is YES, the transmission control module 11 performs release of the lock-up clutch 6 at the lock-up release vehicle speed VSP₁ (step A06).

On the other hand, if the step A05 is NO, the transmission control module 11 performs release of the lock-up clutch 6 at the lock-up lower limit vehicle speed VSP₂ (step A07).

After a processing of the above-described step A06 or the above-described step A07, the transmission control module 11 returns the program (step A08).

In each map of FIG. 4 and FIG. 5, the target minimum engine rotation frequency Nemin is a rotation frequency made by adding a correction rotation frequency α to a fuel cut recovery rotation frequency inputted from the engine control module 10 to the transmission control module 11. Further, a coast clown rotation frequency is indicated by Nt and a vehicle speed is indicated by VSP. Then, an example of a case of the target minimum engine rotation frequency Nemin>coat down rotation frequency Nt will be presented.

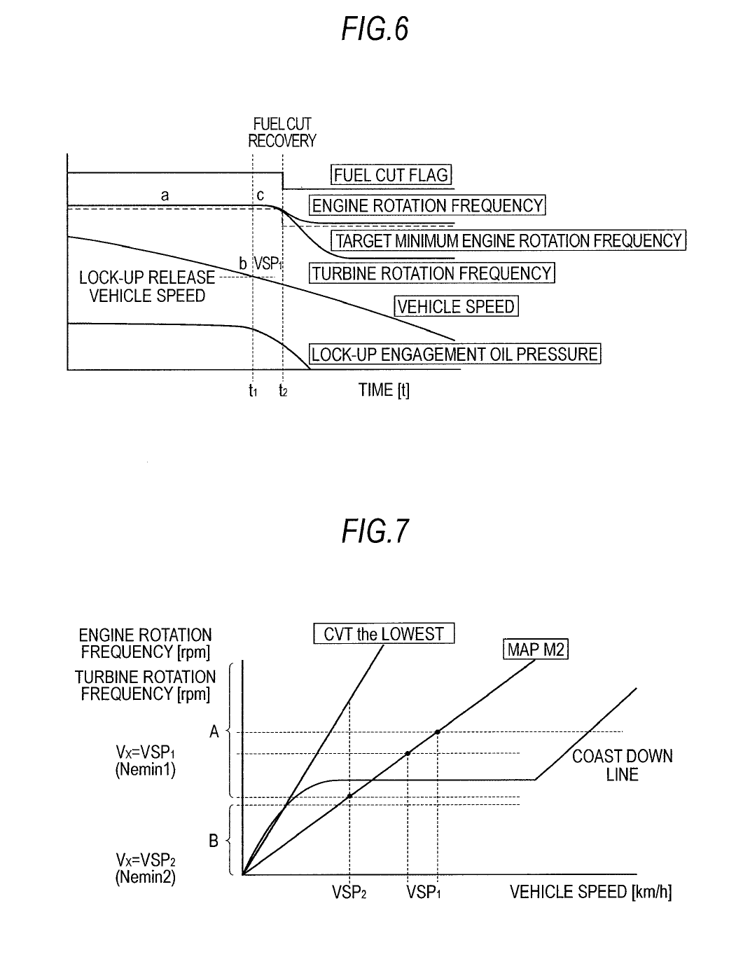

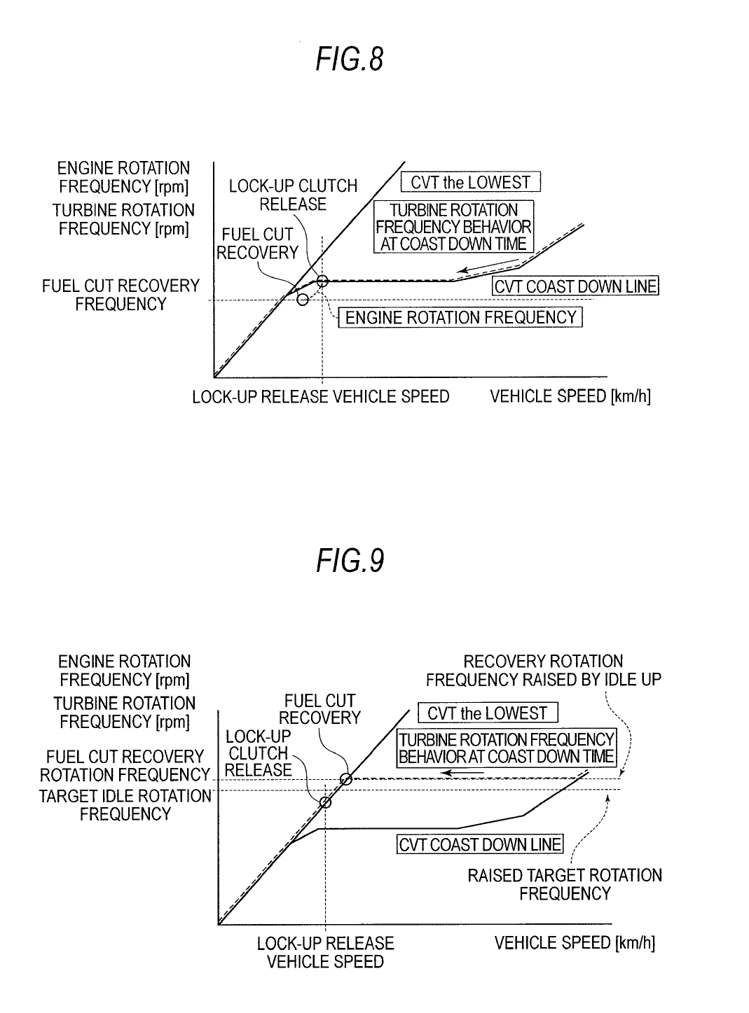

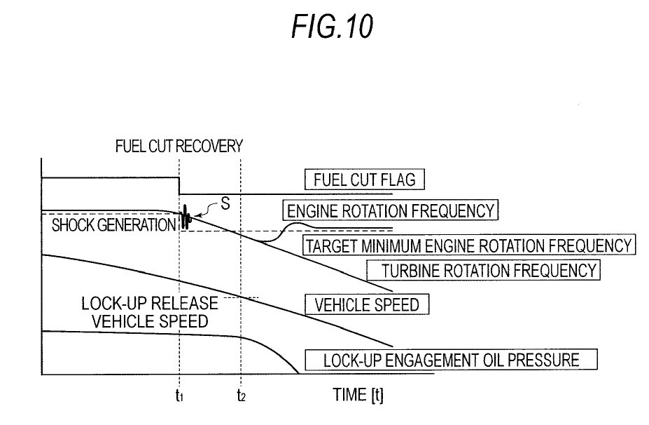

When coast down is performed in a state in which the lock-up clutch 6 is engaged, the cost down rotation frequency Nt is raised by the target minimum engine rotation frequency Nemin (indicated by “a” in FIG. 5 and FIG. 6). Then, the transmission control module 11 calculates, by the map of FIG. 2, a lock-up release vehicle speed VSP_{1 (Nemini)} corresponding to the target minimum engine rotation frequency Nemin1 (indicated by “b” in FIG. 5 and FIG. 6). On the other hand, the transmission control module 11 compares the lock-up release vehicle speed VSP₁ and a lock-up lower limit vehicle speed VSP₂ determined by another predetermined condition. Then, in a case of VSP₁≧VSP₂, the transmission control module 11 performs release of the lock-up clutch 6 at VSP₁ (indicated by “c” in FIG. 5, and FIG. 6). Further, in a case of VSP₂>VSP₁, the transmission control module 11 performs release of the lock-up clutch 6 at VSP₂.

Thereby, an actual engine rotation frequency is not synchronized with an actual turbine rotation frequency under the lock-up release vehicle speed VSP_{1 (Nemini)}. The actual engine rotation frequency is equal to or more than the target minimum engine rotation frequency Nemin1. Then, the turbine rotation frequency changes presenting a behavior to follow the coast down line.

Then, at a time of coast down, the transmission control module 11 releases the lock-up clutch 6 before a transmission ratio of the continuously variable transmission 5 reaches the Lowest. Thereby, it is possible to prevent the engine rotation frequency from becoming less than the target minimum engine rotation frequency Nemin1 before fuel cut recovery, and avoidance of a shock due to fuel cut recovery during engagement the lock-pup clutch 6 is possible.

Further, a speed at which the transmission control module 11 instructs lock-up release is set to be either one of the lock-up release vehicle speed VSP₁ and the lock-up lower limit vehicle speed VSP₂. The lock-up release vehicle speed VSP₁ and the lock-up lower limit vehicle speed VSP₂ are switched depending on a magnitude of the target minimum engine rotation frequency Nemin (Nemim1, Nemim2).

In other words, in a case of the target minimum engine rotation frequency Nemim1, the lock-up release vehicle speed VSP₁ is larger than the lock-up lower limit vehicle speed VSP₂. Accordingly, the transmission control module 11 performs lock-up release at the lock-up release vehicle speed VSP₁.

On the other hand, in a case of the target minimum engine rotation frequency Nemin2, the lock-up release vehicle speed VSP₁ is smaller than the lock-up lower limit vehicle speed VSP₂. Accordingly, the transmission control module 11 performs lock-up release at the lock-up lower limit vehicle speed VSP₂.

Thus, when the target minimum engine rotation frequency Nemin is low (Nemin2), a fuel cut state can be maintained until reaching a low vehicle speed, so that improvement of a fuel efficiency is more possible than in conventional control.

In other words, in this embodiment, as a result that the transmission control module 11 performs control of release of the lock-up clutch 6 in correspondence with a fluctuation of the fuel cut recovery rotation frequency, a conventional problem is improved. Consequently, even in a state in which the fuel cut recovery rotation frequency is high, as presented in FIG. 6, release of the lock-up clutch 6 can be completed before fuel cut recovery (indicated by a time t2 in FIG. 6) without fail (indicated by a time t1 in FIG. 6). Therefore, it is possible to eliminate a possibility of occurrences of a shock and an engine stall at a time of fuel cut recovery.

In other words, in this embodiment, the second map M2 in which the lock-up release vehicle speed and the engine rotation frequency are set is used at a time of coast down. The transmission control module 11 compares the lock-up release vehicle speed which is set by using the second map M2 and the lock-up release vehicle speed which is set by other than the second map M2. Then, the transmission control module 11 sets the lock-up release vehicle speed having a higher value as the lock-up release vehicle speed for releasing the lock-up clutch 6. In the second map of FIG. 5, the map of FIG. 2 is superimposedly presented.

Increase/decrease of the engine rotation frequency and the turbine rotation frequency (input side rotation frequencies of the continuously variable transmission 5) is set linearly in proportion to increase/decrease of the vehicle speed.

In other words, the engine rotation frequency and the turbine rotation frequency are set to overlap with an equal transmission ratio line of a certain transmission ratio. In the map presented in FIG. 2 the engine rotation frequency and the turbine rotation frequency are able to be set by a table and an interpolation calculation.

In order to release the lock-up clutch 6 before fuel cut recovery, the target minimum engine rotation frequency Nemin is set to be an engine rotation frequency somewhat higher than the fuel cut recovery rotation frequency by adding the correction rotation frequency α to the fuel cut recovery rotation frequency.

In normal coast lock-up control, the vehicle speed VSP₂ for releasing the lock-up clutch 6 is set to be a vehicle speed compatible with other predetermined conditions. As other predetermined conditions, there are applied, for example, a condition to maintain a drive state where a feeling of deceleration of a vehicle does not become excessive, a condition to protect each mechanism, and so on.

In the second map of FIG. 5, setting of the coast down line is as follows, when viewed according to decreases of the engine rotation frequency and the turbine rotation frequency (input side rotation frequencies of the continuously variable transmission 5).

In (i), the coast down line is set so that the engine rotation frequency and the turbine rotation frequency are reduced at a transmission ratio (that is, a High side transmission ratio) where a speed reduction ratio is in a smaller side (side in which speed increasing ratio becomes larger).

In (ii), the coast down line is set so that while the engine rotation frequency and the turbine rotation frequency maintain rotation frequencies at comparatively low rotation frequencies the transmission ratio is altered from a small side (High side) of the transmission ratio to a large side (Low side).

In (iii), the coast down line is set so that the engine rotation frequency and the turbine rotation frequency (input side rotation frequencies of the continuously variable transmission 5) are reduced at a transmission ratio (Lowest) where the speed reduction ratio becomes the maximum.

Thus, the coast down line intersects with a lock-up release line of the map of FIG. 2 at a predetermined vehicle speed within a speed range which can be taken at a certain engine rotation frequency maintained constant in the above-described (ii).

Further, from a result of control according to the flowchart of FIG. 3, as can be understood with reference to FIG. 5 and FIG. 7, a speed at which lock-up release is instructed is switched to either one of the lock-up release vehicle speed VSP₂ and the lock-up lower limit vehicle speed VSP₂. A predetermined speed to be a boundary of the switching is a vehicle speed Vx. The vehicle speed Vx is to be switched to either one of the lock-up release vehicle speed VSP₁ and the lock-up lower limit vehicle speed VSP₂, in correspondence with the target minimum engine rotation frequency Nemin.

In other words, which of the lock-up release vehicle speed VSP₁ and the lock-up lower limit vehicle speed VSP₂ the vehicle speed Vx is switched to is determined by whether the target minimum engine rotation frequency Nemin (Nemin1, Nemin2) is larger or smaller than an engine rotation frequency Ne at an intersection of the lock-up lower limit vehicle speed VSP₂ and the second map (map M2).

In FIG. 7, when the target minimum engine rotation frequency Nemin is in a range A (for example, a range of Nemin1), it becomes Vx=VSP₁. On the other hand, when the target minimum engine rotation frequency Nemin is in a range B (for example, a range of Nemin2), it becomes Vx=VSP₂. It should be noted that the lock-up lower limit vehicle speed VSP₂ being the boundary is a predetermined value fixed by the above-described other conditions and thus is determined non-ambiguously.

It is a matter of course that the embodiments are not limited to the above-described embodiment, and various modifications can be made.

For example, by setting a plurality maps of target minimum engine rotation frequencies and vehicle speeds VSP, the present invention can be also applied to a continuously variable transmission with auxiliary transmission mechanism in which a transmission ratio is different by each transmission speed of an auxiliary transmission.

Moreover, a similar effect can be obtained as a result that an engine control module (EOM) uses a map of a lock-up release vehicle speed corresponding to a fuel cut recovery rotation frequency and that a transmission control module (TCM) receives a lock-up prohibition signal.

Further, a similar effect can be obtained as a result that a map of a target minimum engine rotation frequency Nemin and a vehicle speed VSP is not set and that an engine control module (ECM) calculates a lock-up release vehicle speed from the target minimum engine rotation frequency Nemin and a transmission ratio of a continuously variable transmission (CVT).

A control device of a vehicle power transmission mechanism of the present invention improves drivability by giving consideration to overlapping of a change of an engine rotation frequency and an alteration/fluctuation of a target engine frequency in accordance with a shift property of a continuously variable transmission, and can perform coordinated control without a shock or an engine stall by paying attention to timings of lock-up release and fuel cut recovery during deceleration of a vehicle.

It should be noted that the above embodiments merely illustrate concrete example of implementing the present invention, and the technical, scope of the present invention is not to be construed in a restrictive manner by these embodiments. That is, the present invention may be implemented in various forms without departing from the technical spirit or main features thereof.

A control device of a vehicle power transmission mechanism according to the present invention is applicable also to a continuously variable transmission using a motor, the continuously variable transmission being used in a hybrid vehicle.

What is claimed is:

1. A control device of a vehicle power transmission mechanism connected to an internal combustion engine in which fuel cut and recovery is performed at a time of deceleration of a vehicle, the vehicle power transmission mechanism including a continuously variable transmission and a hydraulic power transmission unit with lock-up clutch, the control device of the vehicle power transmission mechanism being provided with a first map by which lock-up control of controlling engagement or release of the lock-up clutch is performed at a time of satisfaction of a predetermined condition and by which coast down control of altering a transmission ratio of the continuously variable transmission at a time of deceleration of the vehicle can be performed, the control device of the vehicle power transmission mechanism comprising:
a second map which is set by making a lock-up release vehicle speed at which the lock-up clutch is released and an engine rotation frequency correspond to each other, wherein
when coast down control is performed, said second map is used to set a lock-up release vehicle speed at which the lock-up clutch is released.

2. The control device of the vehicle power transmission mechanism according to claim 1, wherein
the lock-up release vehicle speed set by using said second map and a lock-up release vehicle speed set by other than said second map are compared and the lock-up release vehicle speed with a higher value is set as the lock-up release vehicle speed at which the lock-up clutch is released.
